(19) United States
(12) Patent Application Publication
(10) Pub. No.: US 2009/0236576 A1
(43) Pub. Date: Sep. 24, 2009

(54) Auxiliay winch for automobile

(76) Inventor: LIAO TER CHOU, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,675

(22) Filed: Mar. 21, 2008

(51) Int. Cl. B66D 1/00

(52) U.S. Cl. 254/323

(57) ABSTRACT

A winch is provided for mounting to a wheel of an automobile, including spaced and opposite first and second disks connected by an axle, a cable having a distal end forming a hook, and two nut members. The first disk forms two through holes at opposite locations and each through hole is constituted by a small-diameter outer hole section and a large-diameter inner hole section to form a circumferential internal shoulder therebetween, serving to support a nut member received in the through hole. The second disk forms two bores corresponding to the through holes for the extension of a tool for tightening the nut member. The axle has an outer circumference forming a notch to which a proximal end of the cable is received and fixed. The first disk is secured to the wheel by the nut members received in the through holes and engaging wheel studs. The hook of the cable can be releasably attached to a fixed object so that by operating an engine of the automobile to rotate the wheel, the axle winds the cable thereon to induce a driving force to the automobile by the cable thereby freeing the automobile from for example trapping mud.

### BACKGROUND OF THE INVENTION

1. Field of the Invention

The present invention relates to an auxiliary winch for automobiles, and in particular to a winch comprising an axle connecting between spaced first and second disks and coupled to a cable having an end forming a hook and two nut members that releasably mounting the winch to a wheel of automobile so that when an automobile is trapped in for example mud, the driver of the automobile may easily and efficiency install the winch on the wheel of the automobile to help the automobile get rid of the trapped condition.

2. The Related Arts

Special-purpose vehicles or rescue vehicles, jeeps and mountain-climbing vehicles are often provided with a winch to provide rescue function. For example, when the automobile or vehicle is trapped in mud, a recess, or a slipping road surface and is thus not able to move further, the winch that is provided on the automobile may be used to get the automobile out of the trap or the winch can be used to rescue other trapped vehicles.

The known winch is often arranged to receive mechanical power from an engine of vehicle to provide power for the winch. Also, a substantial space is needed to install the winch. Due to these reasons, the conventional automobile winch is often installed on the special-purpose vehicles or rescue vehicles and jeeps and is not suitable for regular automobiles, such as a sedan. Apparently, a regular vehicle, when trapped and incapable to further move, cannot self rescue and has to wait for a rescue vehicle to get it out of the trap.

Thus, it is desired to have an automobile winch that overcomes the above discussed deficiencies.

### SUMMARY OF THE INVENTION

To overcome the above discussed deficiencies, the present invention is aimed to provide an auxiliary winch for automobiles.

In other words, an objective of the present invention is to provide an auxiliary winch for automobiles, which winch can be easily and efficiently mounted to a wheel of the automobile by a driver of the automobile in order to release the automobile from a trapped condition.

To achieve the above objective, a technique solution in accordance with the present invention is as follows.

The present invention provides a winch that is adapted to install in an automobile, comprising a first disk and a second disk that are spaced from each other and connected together by an axle therebetween, a cable having a distal end forming a hook, and at least two nut members.

The first disk forms therethrough two through holes at opposite locations for receiving the nut members respectively. Each through hole is comprised of an outer hole section having a small diameter and an inner hole section having a large diameter so that a circumferential internal shoulder is formed between the inner hole section and the outer hole section, functioning to support and retain the nut member.

The second disk forms two bores therethrough, corresponding in location to the through holes of the first disk.

The axle is arranged between and is integrally formed with the first and second disks. The axle has an outer circumference forming a notch to which a proximal end of the cable is received and fixed.

In a practical application, to install the winch, a tool is used to remove two lug nuts from wheel studs that fix a wheel to an automobile. The first disk is then mounted to the wheel by fitting the through holes over the wheel studs and tightening with the nut members that engage the wheel studs.

To operate, the hook of the distal end of the cable is attached to a fixed object and the proximal end of the cable is fixed to the axle. By starting an engine of the automobile and driving the wheel to rotate at a low speed, the axle winds the cable thereon and thus inducing a towing or driving force in the cable that moves the automobile, which may be for example trapped in mud, out of the trapped condition.

The present invention provides a winch that is of a simple structure and has a compact arrangement for ready storage. The installation of the winch is also easily and efficiently. Thus, the winch in accordance with the present invention is most suitable for mounting to an automobile that is not equipped with a power winch to function to for example rescue the automobile out of a trapped condition.

### BRIEF DESCRIPTION OF THE DRAWINGS

The present invention will be apparent to those skilled in the art by reading the following description of preferred embodiments thereof, with reference to the attached drawings, wherein:

FIG. 1 shows a perspective view of a winch constructed in accordance with the present invention;

FIG. 2 illustrates mounting the winch of the present invention to a wheel of an automobile;

FIG. 3 shows a perspective view of the winch of the present invention mounted to the automobile wheel; and

FIG. 4 shows a cross-sectional view of the winch of the present invention mounted to the automobile wheel.

### DETAILED DESCRIPTION OF THE PREFERRED EMBODIMENTS

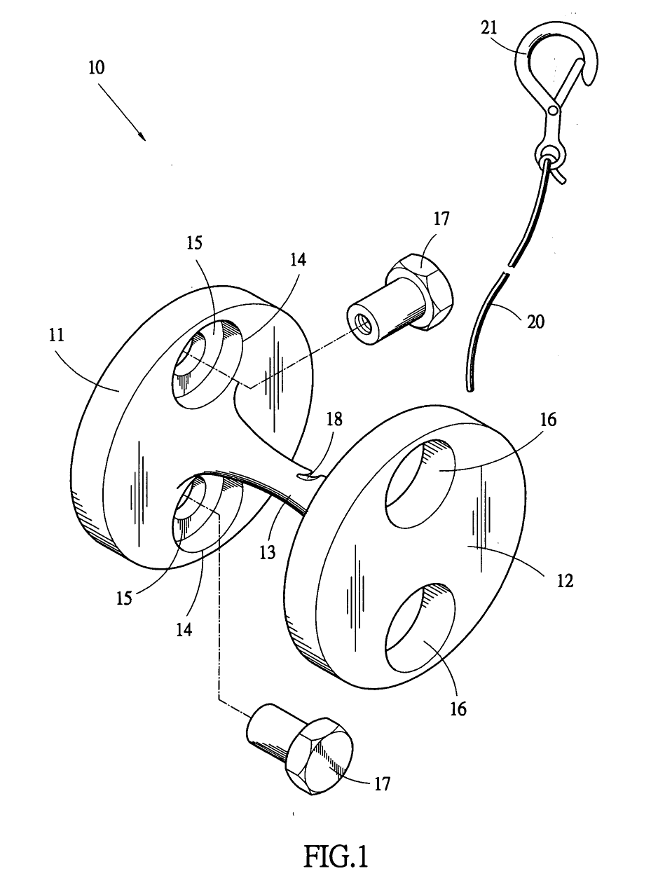

With reference to the drawings and in particular to FIG. 1, which shows a perspective view of a winch constructed in accordance with the present invention, generally designated with reference numeral 10, the winch 10, which is provided to serve as an auxiliary winch for automobiles, comprises a first disk 11 and a second disk 12 that are coupled to each other by an axle 13 and a cable 20 having a distal end to which a hook 21 is mounted and at least two nut members 16. Preferably, the first disk 11 and the second disk 12 are opposite to and spaced from each other.

The first disk 11 forms at least two through holes 14 at opposite locations. Each through hole 14 is constituted by first and second sections, which are respectively located close to outer and inner sides of the first disk 11 and have small and large diameters so that the through hole 14 includes an outer hole section having a small diameter and an inner hole section having a large diameter and a circumferential internal shoulder 15 is formed between the small-diameter outer hole section and the large-diameter inner hole section of the through hole 14.

The second disk 12 forms therethrough a bore 16 corresponding in location to each through hole 14 of the first disk 11 for the extension of a tool (not shown) that may be used ton install the winch 10 to an automobile (not shown).

As shown in FIG. 1, the axle 13 is preferably integrally formed with and arranged between the first and second disks 11, 12. The axle 13 has an outer circumference in which a notch 18 is formed for tightening of a proximal end of the cable 20.

In a practical embodiment of the present invention, the axle 13 is made of a shape having two ends that are of increased diameters, while a central portion of the axle 13 being of a relatively small diameter, so that the axle 13, when viewed sideways, has a concave curved shape. In this way, structural strength of the connection between the axle 13 and the first and second disks 11, 12 is enhanced. Further, such a concave curved configuration of the axle 13 also helps organizing turns of the cable 20 when the cable 20 is wound around the axle 13, without causing any undesired entangling of the turns of the cable 20.

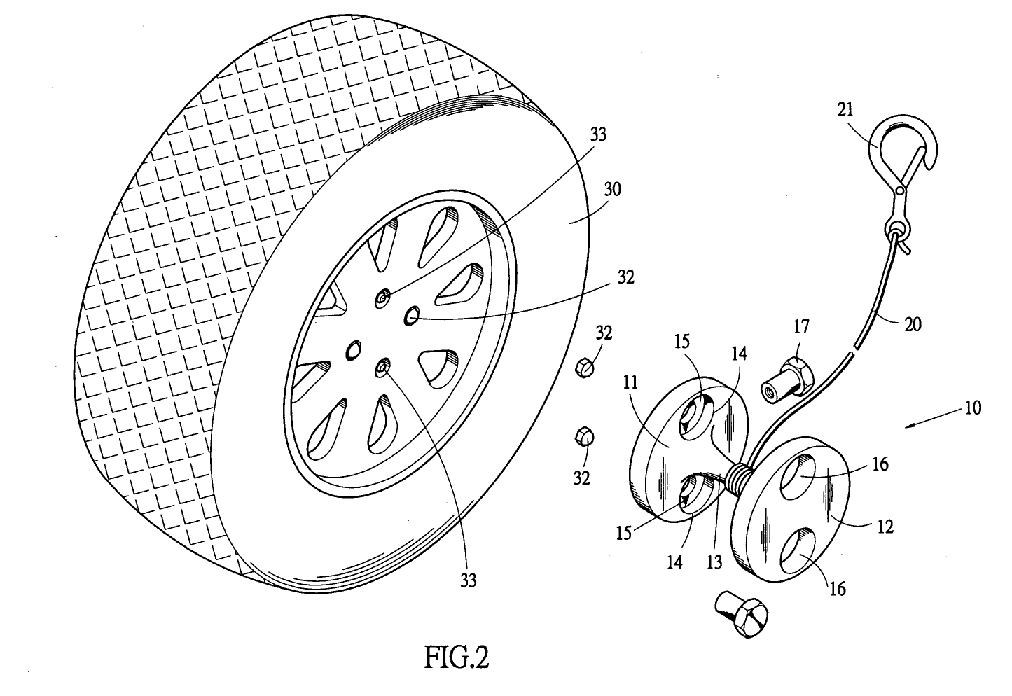

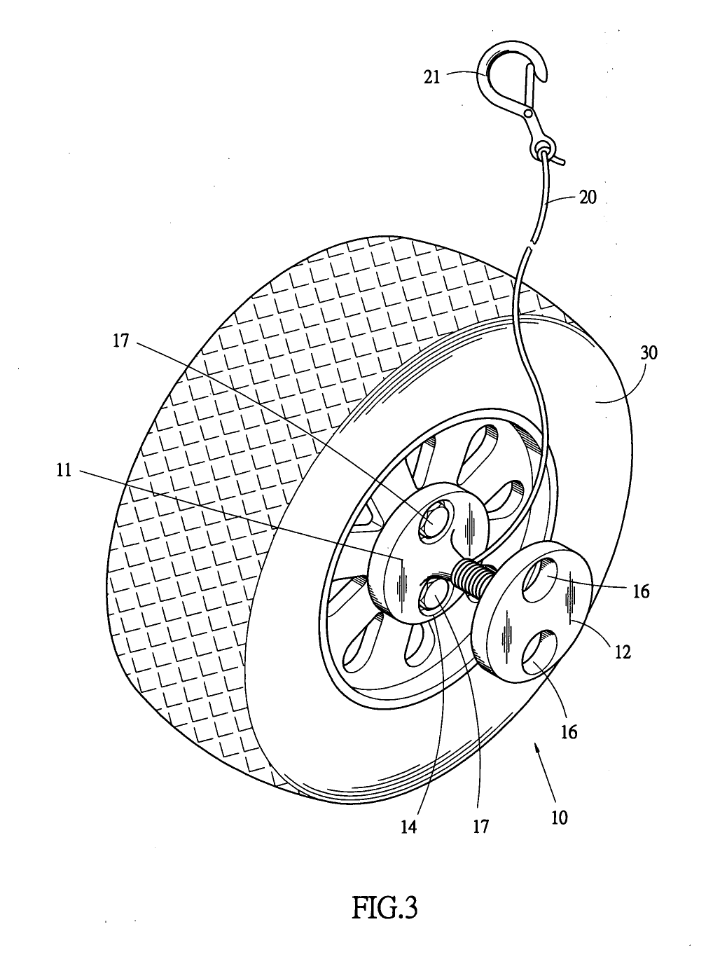

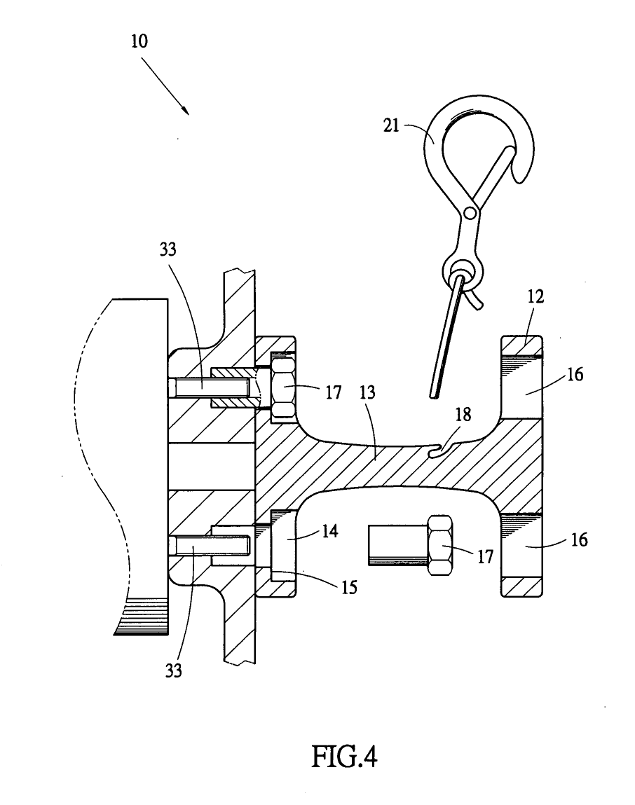

Also referring to FIGS. 2-4, wherein FIG. 2 demonstrates mounting or installing the winch 10 on a wheel 30 of an automobile, FIG. 3 shows a perspective view of the winch 10 that is mounted to the wheel 30, and FIG. 4 shows a cross-sectional view of the winch 10 mounted to the wheel 30, to install winch 10 to an automobile, the winch 10 is mounted to the wheel 30 of the automobile by means of engagement of the nut members 17 with corresponding wheel studs 33 of the wheel 30. This can be done in a way similar to replacement of for example a flat tire by removing two of the lug nuts 32 from the wheel studs 33 of the wheel 30, followed by fitting the first disk 11 to the nut-removed studs 33, and only tire replacement tools are needed in carrying out the installation of the winch 10 to the wheel 30. General consumers, who are capable to replace an automobile tire by themselves, can perform the installation of the winch 10 in a simple and generally efficient manner.

The installation of the winch 10 will be further described in more details. As shown in FIG. 2, two lug nuts 32, preferably two opposite ones, are removed from the corresponding wheel studs 33 of an automobile wheel 30, but the remaining lug nuts 32 are still in tight engagement with the corresponding studs 33 so that the wheel 30 remains securely fixed to a wheel axle and can be driven by the engine (not shown) of the automobile through a transmission system of the automobile.

The first disk 11 is then positioned against the wheel 30 by having the through holes 14 of the first disk 11 fit over the wheel studs 33 of which the lug nuts 32 have been removed. The nut members 17 are then put into engagement with the nut-removed studs 33 and tightened, preferably by means of a tire replacement tool (not shown) that extends through the bores 16 of the second disk 12 to drive the nut members 17. The circumferential internal shoulder 15 of each through hole 14 provides a support to an expanded head of the nut member 17 received in the through hole 14. In this way, the winch 10 is securely fixed to the wheel 30 by the nut members 17 tightly engaging the wheel studs 33, as shown in the perspective view of FIG. 3 and the cross-sectional view of FIG. 4.

Referring to FIG. 3, to operate the winch 10, the hook 20 provided at the distal end of the cable 20 is stretched out and attached to a fixed object, such a tree in front of the automobile to which the winch 10 is mounted. The proximal of the cable 20 is fixed to the axle 13 of the winch 10 by means of the notch 18 and the cable 20 is properly wound around the axle 13 to make the cable 20 properly stretched. Thereafter, the engine of the automobile is started and the transmission of the automobile is set in a low speed to slowly rotate the wheel 30, which causes the axle 13 of the winch 10 to rotate and thus wind the cable 20 thereon so that a towing force is induced and the automobile is moved. In this way, an automobile trapped in mud can rescue itself.

The first and second disks 11, 12 of the winch 10 can be made in similar or identical shape or they can be made in different shapes or configurations. Or, they can be made in a shape and/or size in accordance with the specifications of the wheels to which the winch 10 is to be mounted, including different shapes and different sizes.

If desired, the first disk 11 of the winch 10 can be provided with more or less than two through holes 14 in accordance with different specifications of the wheels to which the winch 10 is to be mounted.

To this point, it is apparent that the winch 10 of the present invention is of a simple structure and can thus be of a small size suitable for storage in a storage cabin of an automobile. Further, installation of the winch 10 of the present invention is also easy and simple and is most suitable for any vehicle that is not equipped with a power winch to provide the function of self rescue as well as a rescue device for other trapped vehicles.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A winch adapted to be mounted to an automobile comprising a wheel, the winch comprising:
a first disk forming two through holes therethrough at opposite locations, each through hole having an outer hole section having a first diameter and an inner hole section having a second diameter, the second diameter being greater than the first diameter so that a circumferential internal shoulder is formed between the outer hole section and the inner hole section;
a second disk opposite to and spaced from the first disk and forming two bores corresponding in position to the through holes of the first disk, the bores being adapted to receive extension of a tool;
an axle arranged between and integrally connected with the first and second disks;
a cable having a distal end to which a hook is mounted and a proximal end secured to the axle; and
a nut member receivable in each through hole of the first disk to engage a wheel stud of the wheel and being retained in the through hole by having a portion thereof abutting against the circumferential internal shoulder of the through hole so as to secure the first disk, and thus the axle and the second disk, to the wheel.

2. The winch as claimed in claim 1, wherein the axle has an outer circumference in which a notch is defined to receive and fix the proximal end of the cable.

3. The winch as claimed in claim 1, wherein the axle has a central portion and two opposite end portions that have increased diameter so that the axle assumes a concave curved shape.

4. The winch as claimed in claim 1, wherein the first and second disks are of identical shape.

5. The winch as claimed in claim 1, wherein the first and second disks are of different shapes.

6. The winch as claimed in claim 1, wherein the first and second disks are of shapes in accordance with specification of the wheel.

7. The winch as claimed in claim 1, wherein the first disk selectively forms more than two through holes in accordance with specification of the wheel.
